(19) United States
(12) Patent Application Publication
(10) Pub. No.: US 2026/0202871 A1
(43) Pub. Date: Jul. 16, 2026

(54) JOYSTICK STRUCTURE

(71) Applicant: SHENZHEN GULI TECHNOLOGY CO., LTD., SHENZHEN (CN)

(72) Inventor: HONGYONG YU, SHENZHEN (CN)

(21) Appl. No.: 19/564,335

(22) Filed: Mar. 12, 2026

Related U.S. Application Data
(63) Continuation-in-part of application No. 19/097,828, filed on Apr. 1, 2025.
Application No. 19/097,828 is a division of application No. 17/715,063, filed on Apr. 7, 2022, now Pat. No. 12,298,800.

(30) Foreign Application Priority Data
Apr. 21, 2021 (CN) 202120831610.1
Apr. 25, 2021 (CN) 202120864065.6

(51) Int. Cl. G05G 9/047

(52) U.S. Cl. CPC G05G 9/047; G05G 2009/04755

(57) ABSTRACT

The present invention discloses a joystick structure, including a rod seat, a joystick, a linkage portion, a first rotating portion, a magnet, a first side cap and a magnetic induction module. The rod seat has a first sidewall, the joystick is movably arranged on the rod seat, the linkage portion is arranged on the rod seat, the first rotating portion is connected to the linkage portion and protrudes from the first sidewall, the magnet is fixedly connected to the first rotating portion, the first side cap is fixedly connected to the first sidewall to receive the first rotating portion, and the magnetic induction module is integrally connected to the first side cap. The joystick and the linkage portion are linked to drive the magnet to rotate relative to the first side cap and the magnetic induction module through the first rotating portion.

### CROSS REFERENCE TO RELATED APPLICATIONS

This application is a continuation-in-part of American Patent Application No. 19/097,828, entitled “HALL JOYSTICK”, filed on April 1, 2025, which is incorporated herein by reference in its entirety.

### BACKGROUND

### 1. Technical Field

The present disclosure generally relates to joysticks, and particularly to a joystick structure.

### 2. Description of Related Art

With the improvement of living standards, people's leisure activities are becoming more and more various. Electronic gaming devices that incorporate various functions, such as leisure and entertainment, intellectual development, emotional intelligence development, and even exercise and fitness are more and more popular. As an important component of electronic gaming devices, the joystick switch (also known as joystick) of a gaming controller is an important part for a user to control electronic games.

Some conventional joysticks may include a frame, a first rotating member, a second rotating member, a stick, a rod seat and a base. The first rotating member is rotatably mounted on the frame. The second rotating member extends in a direction orthogonal to the longitudinal direction of the first rotating member and is rotatably mounted on the frame. The stick can be tilted and the top of the stick extends out of the frame. The rod seat is movable and arranged in an axial direction of the stick. The base is arranged at the lower part of the frame. A spring is usually arranged between the stick and the rod seat, and the spring is to return the stick to its original position. Electronic components are mounted on a housing.

These conventional joysticks have the following drawbacks: the electronic components are mounted on the housing and are located outside the frame, which makes the electrical components protrude from the whole, resulting in a large product size and hindering the integrated development of products. In addition, there are many parts and the structure is complicated, resulting in low production efficiency.

Some analog control joysticks on the market generally adopt the resistive film structure, which is simple in structure and low in cost. However, because of the sliding rheostat structure that the metal or carbon brush slides directly on the resistive film to detect the position of the joysticks, these joysticks suffer from the problems of short service life, easy drift, and low precision. Trackball Hall sensors use 4 Hall devices to calculate the positions on the X and Y axes. Multiple Hall devices may suffer from the problems of high failure rate, high cost and complex calculation.

Therefore, there is a need to provide a Hall joystick to overcome above-mentioned problem.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic isometric view of a joystick structure according to a first embodiment.

FIG. 2 is a planar cross-sectional view of the joystick structure according to one embodiment.

FIG. 3 is an isometric exploded view of the joystick structure according to one embodiment.

FIG. 4 is an enlarged view of a portion A of FIG. 1.

FIG. 5 is an enlarged view of a portion B of FIG. 2.

FIG. 6 is an enlarged view of a portion C of FIG. 3.

FIG. 7 a schematic isometric view of the joystick structure viewed from a different perspective.

FIG. 8 is another isometric exploded view of the joystick structure according to one embodiment.

FIG. 9 is another isometric exploded view of the joystick structure according to one embodiment.

FIG. 10 is an isometric exploded view of a side cap of the joystick structure according to one embodiment.

FIG. 11 is a schematic diagram of a joystick structure according to a second embodiment.

FIG. 12 is an exploded view of the joystick structure shown in FIG. 11.

FIG. 13 is a sectional view of the joystick structure shown in FIG. 11.

FIG. 14 is another exploded view of the joystick structure shown in FIG. 11.

FIG. 15 is an exploded view of a joystick, a return spring and an inner rod of the joystick structure shown in FIG. 14.

FIG. 16 is a schematic diagram of the joystick of the joystick structure shown in FIG. 15.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

### First embodiment

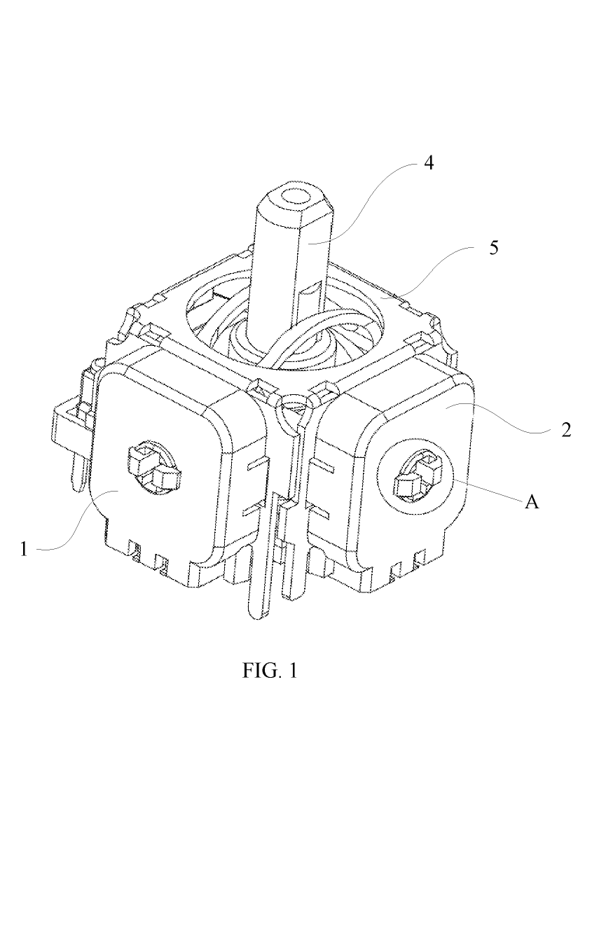

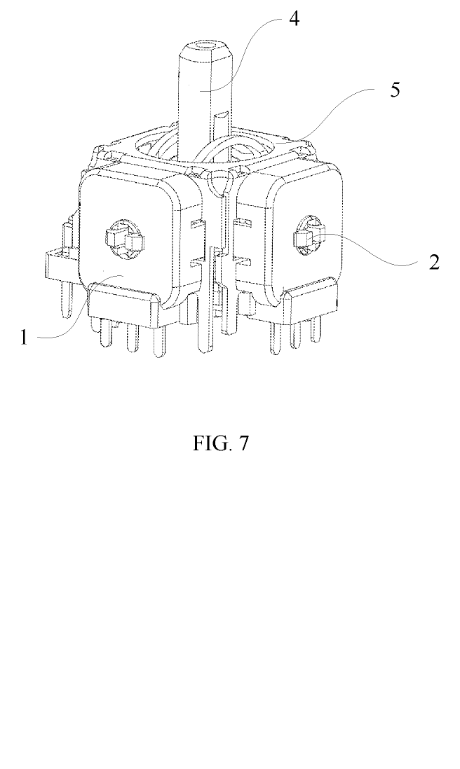

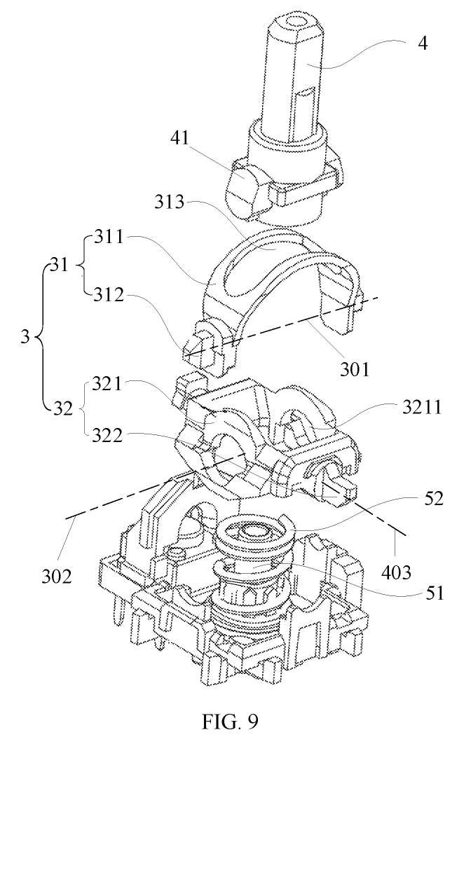

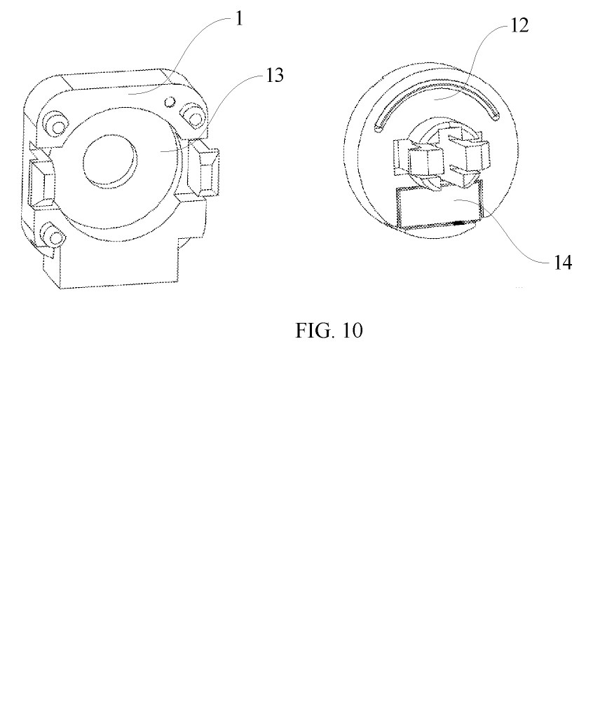

Referring to FIGS. 1-10, the first embodiment of the present invention discloses a joystick structure, including a return spring 52, a linkage portion 3 (see FIG. 9), a first side cap 1, a second cap 2, a joystick 4, and a rod seat 5. The rod seat 5 is hollow and includes a first side surface 501 and a second side surface 502 that are perpendicular to each other. The return spring 52 is arranged within the rod seat 5. The first side cap 1 and the second cap 2 are respectively fixed to the fist side surface 501 and the second side surface 502. The joystick 4 is partly received in the rod seat 5 and has a lower end 401 rotatably connected to the rod seat 5. A first rotating portion 12 and a second rotating portion 22 are rotatably connected to the first side cap 1 and the second side cap 2. Each of the first rotating portion 12 and the second rotating portion 22 includes a magnet 14 attached thereto. The linkage portion 3 is movably arranged in the rod seat 5 and connected to the joystick 4, the first rotating portion 12 and the second rotating portion 22. The linkage portion 3 is to transmit a rotational motion from the joystick 4 to the first rotating portion 12 and the second rotating portion 22, which drives the first rotating portion 12 and the second rotating portion 22 to rotate with respect to the first side cap 1 and the second side cap 2, respectively. A first magnetic induction module 11 is arranged within the first side cap 1, and a second magnetic induction module 21 is arranged within the second side cap. In one embodiment, the first magnetic induction module 11 may be arranged under the magnet 14 in the first rotating portion 12, and the second magnetic induction module 21 may be arranged under the magnet 14 in the second rotating portion 22.

In one embodiment, the return spring 52 is to urge the joystick 4 to automatically return to its original position (e.g., a position where the joystick 4 is vertical and extends along a vertical line passing through the center of the rod seat 5) when there is no external force exerted on the joystick 4. The configuration above enables the magnet 14 inside the first rotating portion 12 to rotate and enables the magnet 14 inside the second rotating portion 22 to rotate through the linkage portion 3. The first magnetic induction module 11 under the magnet 14 on the first rotating portion 12 can detect the change in magnetic field caused by the rotation of the magnet 14 on the first rotating portion 12. The second magnetic induction module 21 under the magnet 14 on the second rotating portion 22 can detect the change in magnetic field caused by the rotation of the magnet 14 on the second rotating portion 22. The first magnetic induction module 11 is positioned inside and integrally connected to the first side cap 1, and the second magnetic induction module 21 is positioned inside and integrally connected to the second side cap 2. The first magnetic induction module 11 and the second magnetic induction module 21 are integrally connected with the corresponding side caps, before the joystick structure is assembled to an external PCB, such as a motherboard of a gamepad, the first magnetic induction module 11 and the corresponding magnet 14 can be aligned, and the second magnetic induction module 21 and the corresponding magnet 14 can be aligned, so that the relative positions of the first magnetic induction module 11, the second magnetic induction module 21 and the corresponding magnets 14 have better consistency, thus facilitating later correction. When assembled on the assembly line, rapid assembling can be achieved by insertion of the pins on the first magnetic induction module 11 and the second magnetic induction module 21 to an external PCB, such as a motherboard of a gamepad. It also realizes the non-contact position detection of the joystick structure, with long service life, high precision and no drift problem. In addition, the manner in which the first side cap 1 and the second side cap 2 are arranged enables two magnetic induction sensors (i.e., the two magnetic induction modules) to detect the position of the joystick 4, which has the advantages of simple structure, low power consumption, simple detection operation, and lower cost.

In one embodiment, the internal structures of the first side cap 1 and the second side cap 2 are the same. For example, an in-mold poly-molding process can be used to integrally arrange the first magnetic induction module 11 inside the first side cap 1, and integrally arrange the second magnetic induction module 21 inside the second side cap 2, thus realizing the integral connection of the first magnetic induction module 11 and the first side cap 1 and the integral connection of the second magnetic induction module 21 and the second side cap 2.

In one embodiment, the rod seat 5 includes therein a inner rod 51. The spring 52 is arranged around the post 51. The joystick 4 defines a hollow space 402, and the post 51 is received in the hollow space 402. An upper end of the return spring 52 abuts against the joystick 4. The joystick 4 is rotatable together with the inner rod 51 about a lower end of the post 51 in contact with the rod seat 5.

The provision of the post 51 enables the joystick 4 to automatically return to its original position (e.g., a position where the joystick 4 is vertical and extends along a vertical line passing through the center of the rod seat 5) quickly when there is no external force exerted on the joystick 4, and enables the joystick 4 to rotate smoothly.

Referring to FGI. 9, in one embodiment, the linkage portion 3 may include a first linkage portion 31 and a second linkage portion 32 that are rotatably connected to the rod seat 5 and rotatable about two different axes 301 and 302. The joystick 4 is rotatably connected to the second linkage portion 32, and is rotatable about an axis of rotation 403. In the embodiment, the axis of rotation 403 coincides with the axis 301. In the embodiment, the two axes 301 and 302 are perpendicular to each other. In one embodiment, the first linkage portion 31 may include a first driving portion 311, and the second linkage portion 32 may include a second driving portion 321 that is formed by four sidewalls connected to one another. In the embodiment, two opposite sidewalls define two through holes 3211, and the joystick 4 includes two shaft portion 41 that are rotatably received in the two through holes 3211. The first linkage portion 31 defines a groove 313 in the first driving portion 311. The joystick 4 passes through the second driving portion 321 and the groove 313 and is movable along the groove 313 when the joystick 4 rotates together with the second linkage portion 32. The joystick 4 is to push the first linkage portion 31 to rotate when the joystick 4 rotates with respect to the second linkage portion 32.

In one embodiment, the first linkage portion 31 may include a first rotation shaft 312 connected to the first rotating portion 12, and the second linkage portion 32 includes a second rotation shaft 322 connected to the second rotating portion 22.

In one embodiment, when the joystick 4 rotates about the axis of rotation 403 that is perpendicular to the first side cap 1, the joystick 4 will come into contact first driving portion 311 and push the first linkage portion 31 to rotate, thereby causing the first rotation shaft 312 to rotate. The first rotating portion 12 then rotates together with the first rotation shaft 312, thereby causing the magnet 14 within the first rotating portion 12 to rotate. The first magnetic induction module 11 can detect the change in the magnetic field caused by the rotation of the magnet 14 inside the first rotating portion 12.

When the joystick 4 is pushed by a user to move in the groove 313, the second linkage portion 32 rotates about the axis 302 that is perpendicular to the second side cap 2, thereby causing the second rotation shaft 322 to rotate. The second rotating portion 22 then rotates together with the second rotation shaft 322, thereby causing the magnet 14 within the second rotating portion 22 to rotate. The second magnetic induction module 21 can detect the change in the magnetic field caused by the rotation of the magnet 14 inside the second rotating portion 22.

Since the first side cap 1 and the second side cap 2 are perpendicular to each other, the joystick 4 can move to any point in the rod seat 5 according to the combination and decomposition of the movement.

In the above embodiment, the first magnetic induction module 11 is fixedly arranged in the first side cap 1 and located below the magnet 14 on the first rotating portion 12, and the second magnetic induction module 21 is fixedly arranged in the second side cap 2 and located below the magnet 14 on the second rotating portion 22. After the joystick structure is assembled to the external PCB, such as the motherboard of the gamepad, the first magnetic induction module 11 is fixedly arranged to the surface of the external PCB and located below the magnet 14 on the first rotating portion 12, and the second magnetic induction module 21 is fixedly arranged to the surface of the external PCB and located below the magnet 14 on the second rotating portion 22.

In some other embodiments, the first magnetic induction module 11 is fixedly arranged in the first side cap 1 and located on the side of the magnet 14 on the first rotating portion 12. For example, the first magnetic induction module 11 and the corresponding magnet 14 are distributed in the axial direction of the first linkage portion 31. The second magnetic induction module 21 can also be fixedly arranged in the second side cap 2 and located on the side of the magnet 14 on the second rotating portion 22. For example, the second magnetic induction module 21 and the corresponding magnet 14 are distributed in the axial direction of the second linkage portion 32. After the joystick structure is assembled to the external PCB, such as the motherboard of the gamepad, the first magnetic induction module 11 is fixedly arranged to the surface of the external PCB and located on the side of the magnet 14 on the first rotating portion 12, and the second magnetic induction module 21 is fixedly arranged to the surface of the external PCB and located on the side of the magnet 14 on the second rotating portion 22.

It should be noted that the first magnetic induction module 11 and the second magnetic induction module 21 can be arranged at different positions with respect to the magnets 14 depending on actual needs.

In one embodiment, the firs rotating portion 12 is detachably connected to the first side cap 1, and the second rotating portion 22 is detachably connected to the second side cap 2.

The first rotating portion 12 can be detached from the first side cap 1, and the second rotating portion 22 can be detached from the second side cap 2, which is convenient for assembly and disassembly. The first rotating portion 12 and the second rotating portion 22 have the same configuration, and the first side cap 1 and the second side cap 2 have the same configuration.

In one embodiment, the magnets 14 are rectangular.

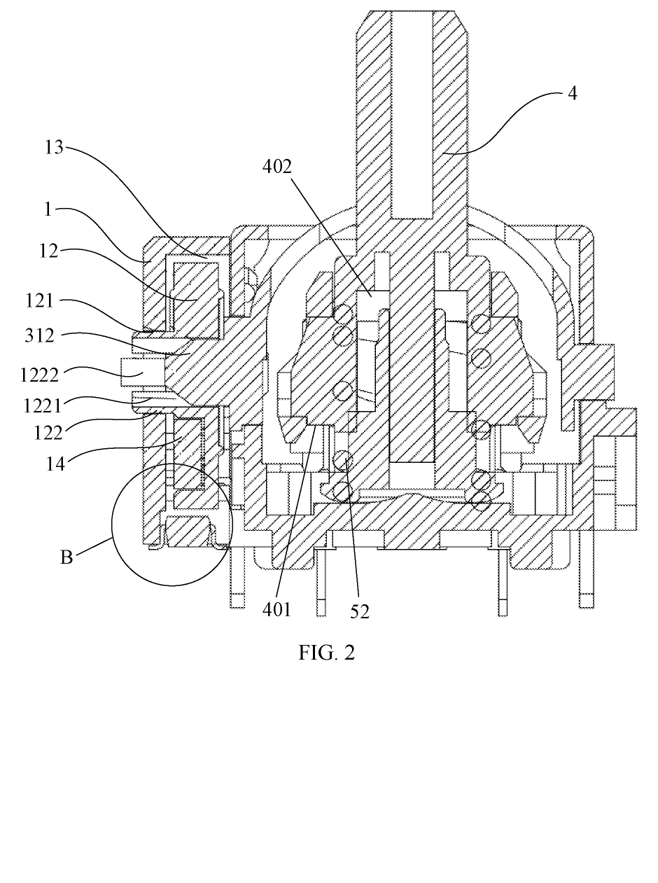

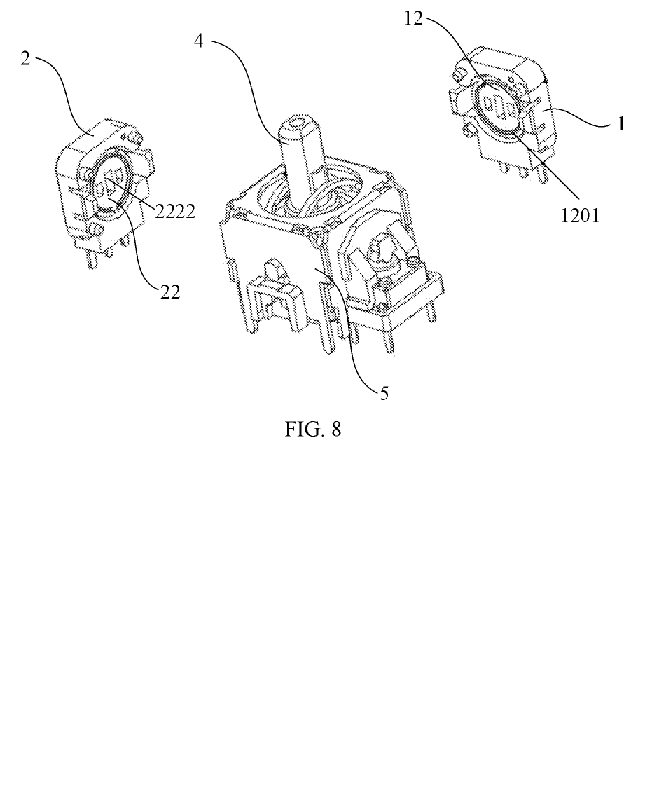

In on embodiment, the first side cap 1 defines a first receiving space 13 (see FIG. 2) to receive the first rotating portion 12, and the second cap 2 defines a second receiving space 1201 (see FIG. 8) to receive the second rotating portion 22.

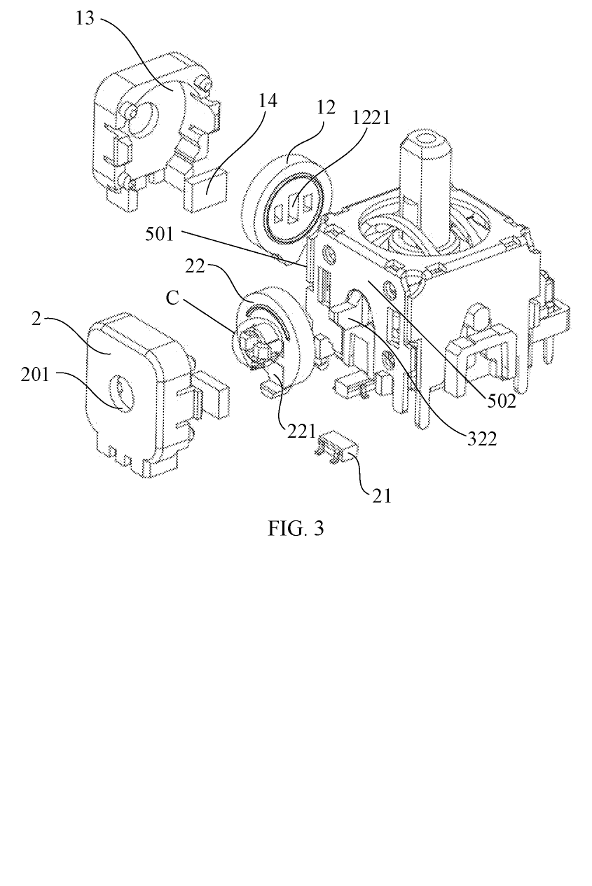

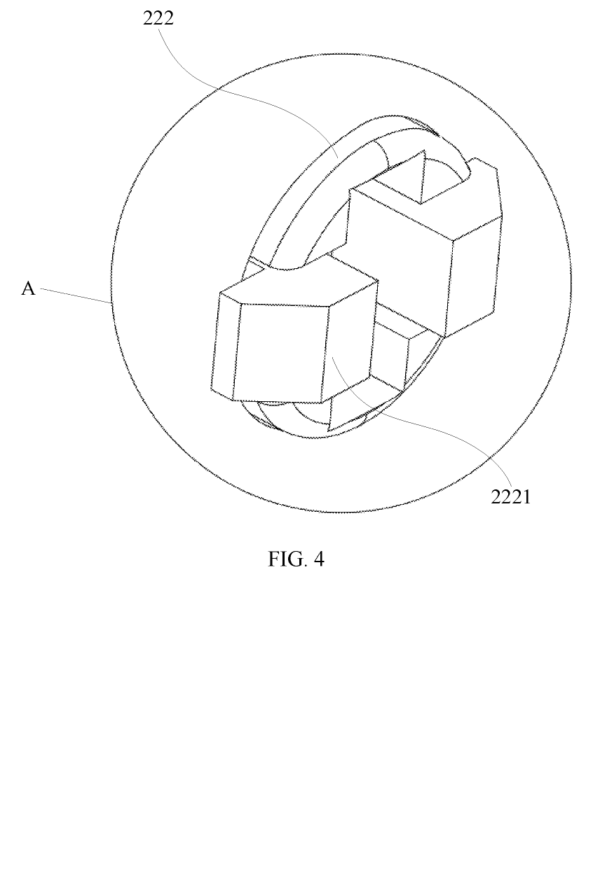

In one embodiment, a first rotation post 122 (see FIG. 2) protrudes from the first rotating portion 12, and the first side cap 1 defines a first rotation slot 121 in communication with the first receiving space 13. The first rotation post 122 passes through the first rotation slot 121. A second rotation post 222 (see FIG. 4) protrudes from the second rotating portion 22, and the second side cap 2 defines a second through hole 201 (see FIG. 3) in communication with the second receiving space 1201. The second rotation post 222 passes through the second through hole 201.

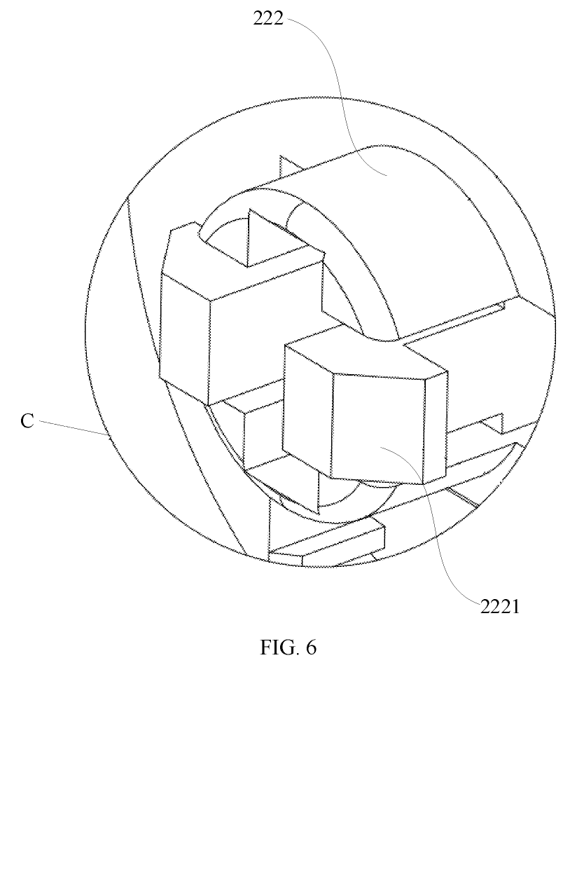

The first rotation post 122 includes a fist hook 1222 (see FIG. 2) at an end thereof, and the first hook 1222 extends out of the first rotation slot 121 and abuts against the first side cap 1. The second rotation post 222 includes a second hook 2221 (see FIGS. 4 and 6) at an end thereof, and the second hook 2221 extends out of the second through hole 201 and abuts against the second side cap 2.

In one embodiment, the first rotation post 122 defines a first locking slot 1221 (see FIG. 3), and the first rotation shaft 312 is fit in the receiving hole 1221 and abuts against the inner surface of the receiving hole 1221. The first rotation post 222 defines a second receiving hole 2222 (see FIG. 8), and the second rotation shaft 322 is fit in the second receiving hole 2222 and abuts against the inner surface of the second receiving hole.

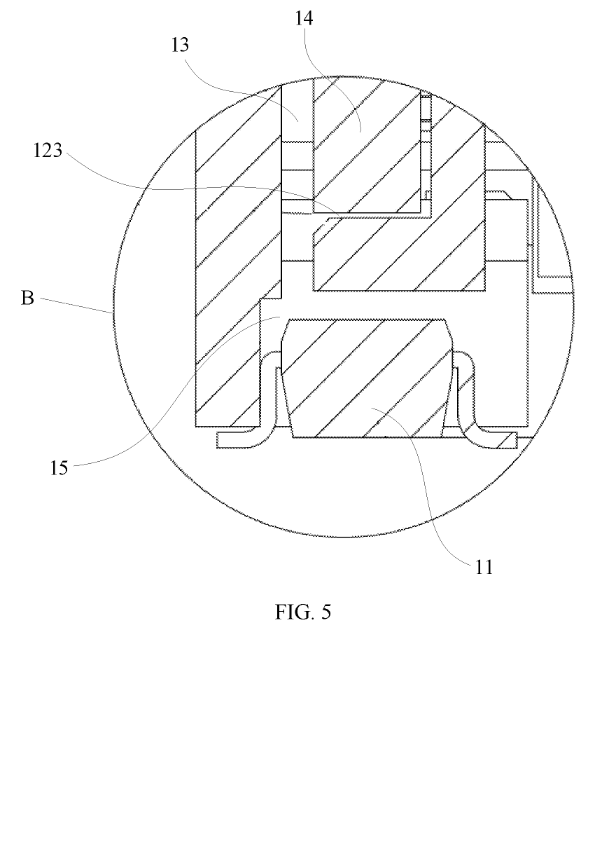

In one embodiment, the first rotating portion 12 defines a first receiving chamber 123 (see FIG. 5), and the second rotating portion 22 defines a second receiving chamber 221 (see FIG. 3). The magnets 14 are arranged in the first receiving chamber 123 and the second receiving chamber 221.

In one embodiment, the first side cap 1 defines a first cavity 15 in communication with the first receiving space 13, and the second side cap 2 defines a second cavity in communication with the second receiving space. The first magnetic induction module 11 and the second magnetic induction module 21 are respectively received in the first cavity 15 and the second cavity.

In some embodiments, the first magnetic induction module 11 and the second magnetic induction module 21 may be Hall sensors respectively. In some other embodiments, the first magnetic induction module 11 and the second magnetic induction module 21 may be tunnel magnetoresistance effect (TMR) sensors or other types of magnetic induction sensors respectively.

### Second Embodiment

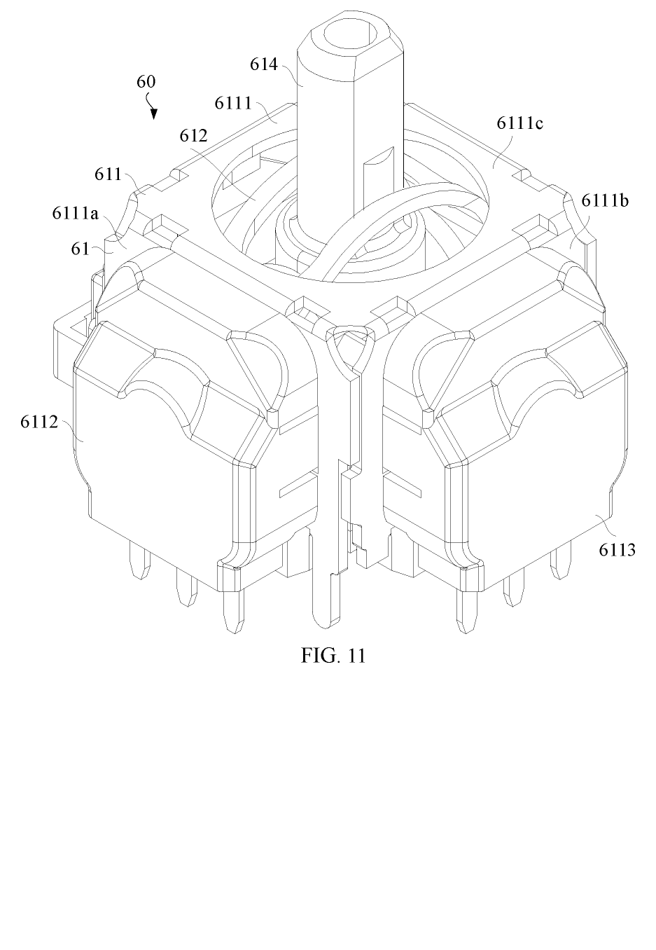

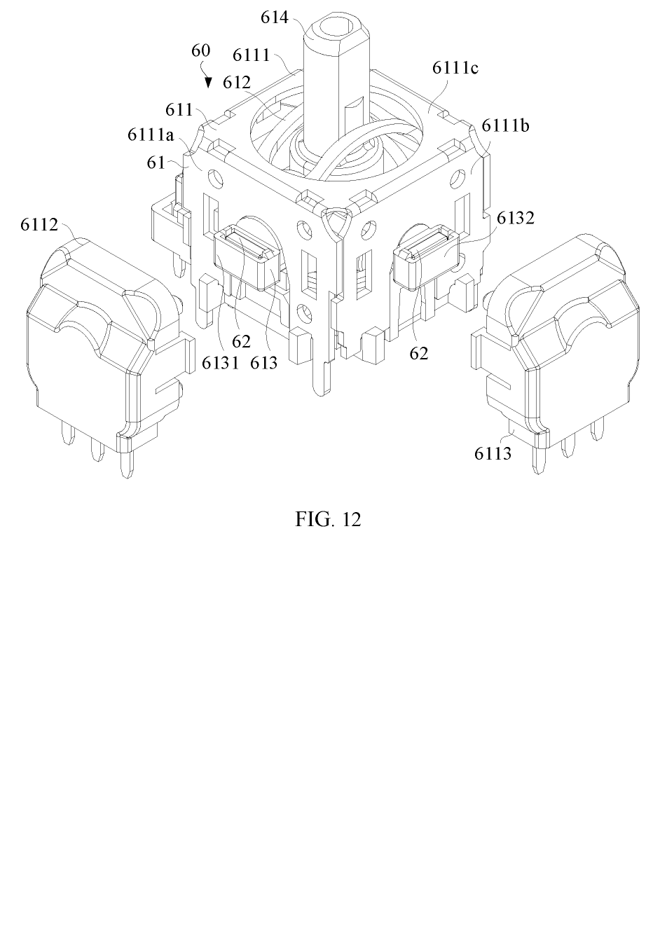

Referring to FIGS. 11, 12 and 13, in the second embodiment of the present application, a joystick structure 60 includes a base 61, a magnet 62 and a magnetic induction module 63, the base 61 includes a housing 611 and a linkage portion 612 movably arranged in the housing 611, the linkage portion 612 is connected to a rotating portion 613, and the magnet 62 is fixed to the rotating portion 613. The magnetic induction module 63 is integrally connected to the housing 611, for example, fixed to the housing 611 by injection molding, and the magnetic induction module 63 is configured to be electrically connected to an external PCB, such as a motherboard of a gamepad. Specifically, the magnetic induction module 63 includes a circuit board 631 and a magnetic induction member 633 connected to the circuit board 631, the magnetic induction member 633 is arranged corresponding to the magnet 62, the circuit board 631 is configured to be connected to the external PCB, such as the motherboard of the gamepad, and the circuit board 631 and the housing 611 can be fixed by injection molding to realize the integral connection of the magnetic induction module 63 and the housing 611.

In some embodiments, the magnetic induction member 633 may be a Hall sensor; in some other embodiments, the magnetic induction member 633 may be a tunnel magnetoresistance effect (TMR) sensor or a magnetic induction sensor of another type. In the production process of the joystick structure 60, the linkage portion 612 is movably arranged on a rod seat 611, the magnetic induction module 63 is integrally connected to the housing 611, and the magnet 62 corresponding to the magnetic induction member 633 of the magnetic induction module 63 is fixed to the rotating portion 613. That is, both the magnetic induction module 63 and the magnet 62 are integrated on the joystick structure 60, and then, the joystick structure 60 is assembled to the external PCB, such as the motherboard of the gamepad, so as to electrically connect the circuit board 631 to the external PCB. For the above joystick structure 60, the magnetic induction member 633 of the magnetic induction module 63 is aligned with the magnet 62 before the joystick structure 60 is assembled to the motherboard of the gamepad, thereby guaranteeing the precision of the alignment between the magnet 62 and the magnetic induction module 63, and then guaranteeing the signal detection precision of the induction module.

Referring to FIGS. 11, 12 and 14, in some embodiments, the housing 611 includes a rod seat 6111, a first side cap 6112 detachably connected to the rod seat 6111 and a second side cap 6113 detachably connected to the rod seat 6111. The linkage portion 612 includes a first linkage portion 6121 and a second linkage portion 6122, the first linkage portion 6121 and the second linkage portion 6122 are movably arranged on the rod seat 6111 respectively, a first rotating portion 6131 arranged corresponding to the first side cap 6112 is connected to the first linkage portion 6121, a second rotating portion 6132 arranged corresponding to the second side cap 6113 is connected to the second linkage portion 6122, each of the first rotating portion 6131 and the second rotating portion 6132 is provided with the magnet 62, and the magnetic induction module 63 is integrally connected to each of the first side cap 6112 and the second side cap 6113. That is, two magnetic induction modules 63 may be provided and connected to the first side cap 6112 and the second side cap 6113 in a one-to-one correspondence manner.

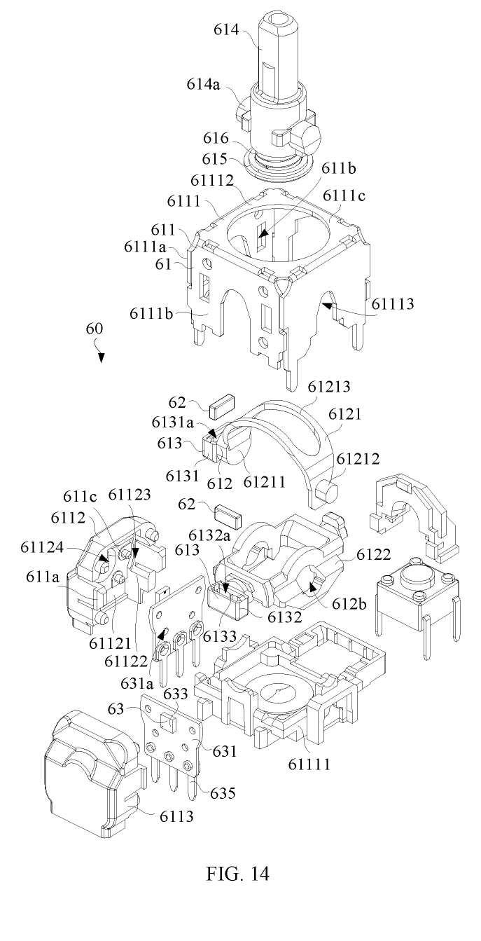

As shown in FIG. 14, the first linkage portion 6121 and the second linkage portion 6122 may be orthogonally arranged in the rod seat 6111. That is, the axes of rotation of the first linkage portion 6121 and the second linkage portion 6122 relative to the rod seat 6111 may be perpendicular to each other, so that the first rotating portion 6131 and the magnet 62 thereon are driven to swing relative to the rod seat 6111 through the first linkage portion 6121, or the second rotating portion 6132 and the magnet 62 thereon are driven to swing relative to the rod seat 6111 through the second linkage portion 6122, thereby realizing the relative movement of the magnet 62 and the magnetic induction module 63 to generate a detection signal.

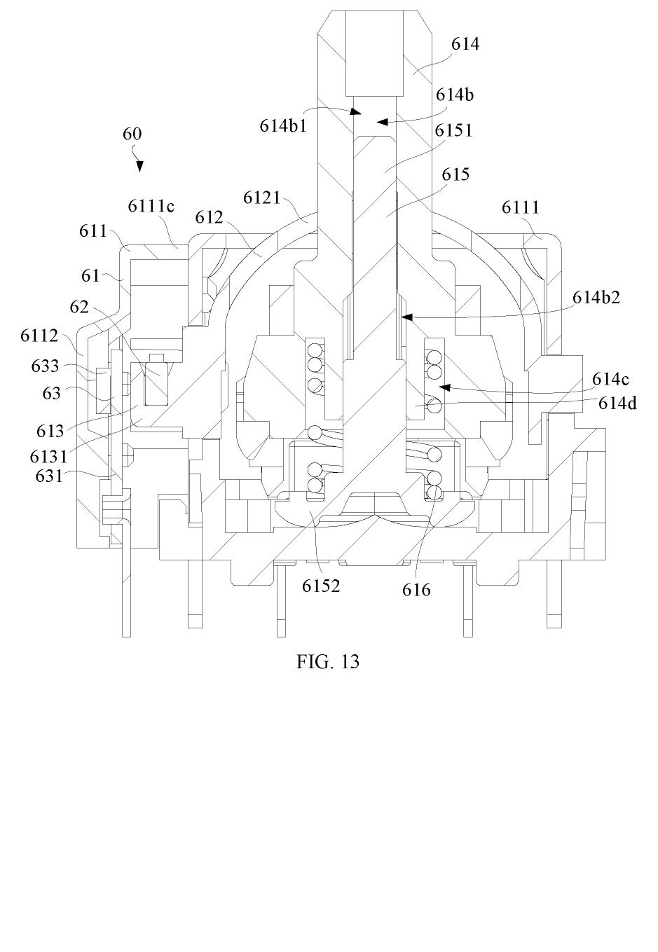

Referring to FIGS. 11, 12, 13 and 14, in some embodiments, the rod seat 6111 may have a first sidewall 6111a and a second sidewall 6111b, the first sidewall 6111a and the second sidewall 6111b are perpendicular to each other, the first side cap 6112 is engaged to the first sidewall 6111a, the second side cap 6113 is engaged to the second sidewall 6111b, the first rotating portion 6131 protrudes from the first sidewall 6111a of the rod seat 6111 and is received in the first side cap 6112, and the second rotating portion 6132 protrudes from the second sidewall 6111b of the rod seat 6111 and is received in the second side cap 6113. Specifically, as shown in FIGS. 13 and 14, taking the first linkage portion 6121 and the first side cap 6112 as an example, the first linkage portion 6121 may include a first end portion 61211, a second end portion 61212 and a driving portion 61213 which are integrally formed, the driving portion 61213 is located between the first end portion 61211 and the second end portion 61212, and the first rotating portion 6131 is formed integrally with the first end portion 61211. The first end portion 61211 and the second end portion 61212 may be directly or indirectly supported by the rod seat 6111 to form swing fulcrums.

The base 61 may further include a joystick 614 movably arranged on the rod seat 6111, and the joystick 614 passes through the driving portion 61213 and the second linkage portion 6122 and is configured to drive the first linkage portion 6121 and the second linkage portion 6122 to swing relative to the rod seat 6111, so as to drive the magnet 62 on the first rotating portion 6131 to swing relative to the rod seat 6111 through the first rotating portion 6131 connected to the first linkage portion 6121, and drive the magnet 62 on the second rotating portion 6132 to swing relative to the rod seat 6111 through the second rotating portion 6132 connected to the second linkage portion 6122. The swing of the first linkage portion 6121 relative to the rod seat 6111 and the swing of the second linkage portion 6122 relative to the rod seat 6111 may be independent of each other. That is, when one of the first linkage portion 6121 and the second linkage portion 6122 swings relative to the rod seat 6111, the other can be substantially stationary relative to the rod seat 6111, so as to realize relatively independent signal output.

With continued reference to FIG. 14, the rod seat 6111 may further include a seat body 61111 and a casing 61112, and the seat body 61111 and the casing 61112 define a limiting hole 61113. When the first linkage portion 6121 is assembled to the rod seat 6111, the first end portion 61211 and the second end portion 61212 of the first linkage portion 6121 respectively pass through the limiting hole 61113 of the rod seat 6111, so as to limit the first linkage portion 6121 to the rod seat 6111. The first rotating portion 6131 is arranged on the side of the first end portion 61211 away from the driving portion 61213, and protrudes from the first sidewall 6111a.

Referring to FIGS. 11, 12 and 14, in some embodiments, one of the first side cap 6112 and the casing 61112 is provided with an engaging member 611a, and the other is provided with an engaging groove 611b. Exemplarily, as shown in FIG. 14, the first side cap 6112 is provided with the engaging member 611a, the casing 61112 is provided with the engaging groove 611b, and the first side cap 6112 is connected to the casing 61112 by matching between the engaging member 611a and the engaging groove 611b. The structure of the second linkage portion 6122 is similar to that of the first linkage portion 6121, and reference may be made to the first linkage portion 6121 and the first side cap 6112 for the arrangement of the second linkage portion 6122 and the second side cap 6113, which is not repeated herein. The second side cap 6113 can also be engaged to the second sidewall 6111b of the casing 61112 through a similar structure, which is not repeated herein.

With continued reference to FIGS. 11, 12 and 14, in some embodiments, the joystick 614 extends out of a third sidewall 6111c of the rod seat 6111, the first sidewall 6111a, the second sidewall 6111b and the third sidewall 6111c are pairwise perpendicular, and the end of the joystick 614 extending out of the rod seat 6111 can be configured to mount a keycap. The second linkage portion 6122 is provided with two opposite connecting holes 612b, the joystick 614 is provided with connecting protrusions 614a matched with the connecting holes 612b, the second linkage portion 6122 sleeves the connecting protrusions 614a of the joystick 614 through the connecting holes 612b, and the second linkage portion 6122 forms a supporting point for the swing of the joystick 614 and limits the joystick 614 in the rod seat 6111, so that the joystick 614 cannot be easily separated from the third sidewall 6111c of the rod seat 6111.

Referring to FIG. 14, in some embodiments, the first rotating portion 6131 is provided with a sunken first placing groove 6131a, the second rotating portion 6132 is provided with a sunken second placing groove 6132a, and the magnets 62 are fixed to the first placing groove 6131a and the second placing groove 6132a respectively. Specifically, taking the first rotating portion 6131 as an example, the magnet 62 may be in a rectangular block shape, the open first placing groove 6131a is formed on the side of the first rotating portion 6131 facing the third sidewall 6111c, the magnet 62 is accommodated in the first placing groove 6131a, and the arrangement of the first placing groove 6131a facing the third sidewall 6111c can prevent the magnet 62 mounted in the first placing groove 6131a from being easily separated under the action of gravity. Further, each of the groove wall of the first placing groove 6131a and the groove wall of the second placing groove 6132a is provided with more than two convex strips 6133, and the convex strips 6133 in the first placing groove 6131a abut against the magnet 62 to engage the magnet 62 in the first placing groove 6131a, so as to limit the magnet 62 in the first placing groove 6131a of the first rotating portion 6131, and prevent the magnet 62 from being easily separated from the first placing groove 6131a.

The open second placing groove 6132a is formed in the side of the second rotating portion 6132 facing the third sidewall 6111c, and the structure can also prevent the magnet 62 mounted in the second placing groove 6132a from being easily separated under the action of gravity. The convex strips 6133 in the second placing groove 6132a abut against the magnet 62 to engage the magnet 62 in the second placing groove 6132a, so as to limit the magnet 62 in the second placing groove 6132a, and prevent the magnet 62 from being easily separated from the second placing groove 6132a.

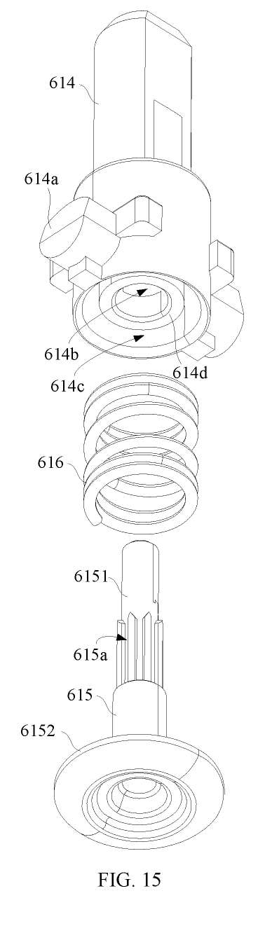

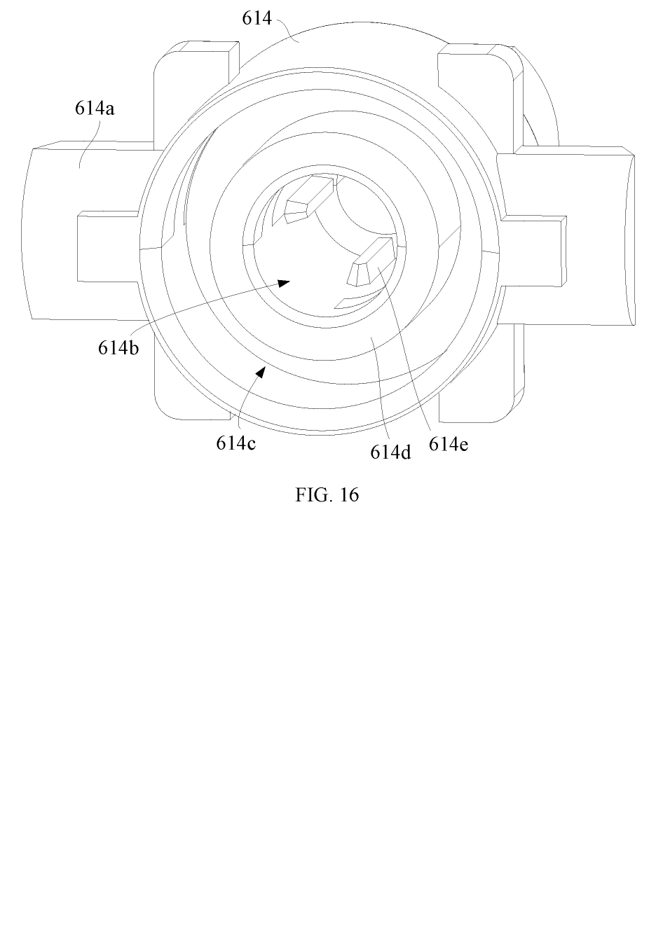

Referring to FIGS. 13, 14, 15 and 16, in some embodiments, the joystick structure 60 can include an inner rod 615 and a return spring 616, the joystick 614 is provided with a through hole 614b and a groove 614c that are spaced apart, and the through hole 614b extends from one end to the other opposite end of the joystick 614 along the axial direction of the joystick 614. One end of the inner rod 615 passes through the through hole 614b, and the other end of the inner rod 615 abuts against the seat body 61111 of the rod seat 6111. The return spring 616 sleeves the inner rod 615, one end of the return spring is received in the groove 614c and abuts against the joystick 614, and the other end of the return spring 616 abuts against the inner rod 615.

Specifically, as shown in FIG. 13, the inner rod 615 may include a rod portion 6151 and a seat portion 6152 arranged at the end of the rod portion 6151 away from the joystick 614, the rod portion 6151 and the seat portion 6152 may be integrally formed, the rod portion 6151 of the inner rod 615 passes through the through hole 614b of the joystick 614, and the seat portion 6152 is configured to abut against the seat body 61111 of the rod seat 6111. The joystick 614 may include a collar 614d protruding from the groove bottom of the groove 614c, and the through hole 614b extends to the end of the collar 614d near the seat portion 6152 in the axial direction of the joystick 614. Due to this structural arrangement, the rod portion 6151 has a larger length and area of contact with the hole wall of the through hole 614b in the axial direction. For example, in an initial state that a user does not apply an acting force to the joystick 614, the rod portion 6151 also protrudes from the third sidewall 6111c. The rod portion 6151 can be a solid rod to ensure the structural rigidity. Since the rod portion 6151 has a larger length and area of contact with the through hole 614b, the stability of the telescopic movement of the inner rod 615 relative to the joystick 614b can be improved.

In some embodiments, when the joystick 614 is assembled, after the rod portion 6151 of the inner rod 615 is sleeved with the return spring 616, the rod portion 6151 passes through the through hole 614b of the joystick 614 to limit the return spring 616. One end of the return spring 616 sleeves the collar 614d of the joystick 614 and abuts against the groove bottom of the groove 614c, and the other end of the return spring 616 abuts against the seat portion 6152 of the inner rod 615. In the process that the user operates the joystick structure 60 through the joystick 614, the inner rod 615 and the joystick 614 can move relatively with the deflection of the joystick 614, so as to generate a pressing effect on the return spring 616, and the elastic restoring force of the return spring 616 can realize centering restoration after the joystick 614 deflects. Due to the structure of the groove 614c, the part of the return spring 616 extending into the joystick 614 can be more effectively limited, thereby avoiding that during the deflection of the joystick 614, the return spring 616 is transversely deformed excessively to result in unstable movement.

With continued reference to FIGS. 13, 15 and 16, in some embodiments, the joystick 614 includes a limiting guide rail 614e protruding from the inner wall of the through hole 614b, the outer wall of the inner rod 615 is provided with a guide groove 615a matched with the limiting guide rail 614e, and the limiting guide rail 614e is matched and in sliding fit with the guide groove 615a to limit the relative rotation of the inner rod 615 and the joystick 614. Specifically, the through hole 614b may include a first section 614b1 and a second section 614b2, the width of the first section 614b1 is less than the width of the second section 614b2, the second section 614b2 is provided with the limiting guide rail 614e, and the rod portion 6151 of the inner rod 615 is provided with the guide groove 615a matched with the limiting guide rail 614e. The limiting guide rail 614e of the joystick 614 is matched and in sliding fit with the guide groove 615a of the inner rod 615 to limit the relative rotation of the inner rod 615 and the joystick 614, which prevents abnormal conditions of the joystick structure 60, such as jamming and deflection, and ensures a stable operation.

Referring to FIGS. 13 and 14, in some embodiments, the first side cap 6112 may include a bottom wall 61121 and a blocking wall 61122 that are integrally formed, the blocking wall 61122 extends along the edge of the bottom wall 61121, the bottom wall 61121 and the blocking wall 61122 together define a receiving cavity 61123, the blocking wall 61122 may be provided with the engaging member 611a, and the engaging member 611a is configured to be detachably connected to the casing 61112 of the rod seat 6111. At least three positioning posts 611c arranged at intervals protrude from the side of the bottom wall 61121 facing the rod seat 6111, the circuit board 631 and the first rotating portion 6131 are received in the receiving cavity 61123, at least three positioning holes 631a in one-to-one correspondence to and in plugged fit with the positioning posts 611c are formed in the circuit board 631, and the magnetic induction member 633 is arranged on the side of the circuit board 631 facing away from the rod seat 6111. The corresponding fit of the positioning holes 631a and the positioning posts 611c can realize assembly positioning of the circuit board 631 in the first side cap 6112, guarantee the positioning precision, and realize the alignment of the magnetic induction member 633 and the magnet 62, and the circuit board 631 can be stably limited in the receiving cavity 61123 of the first side cap 6112 in conjunction with the integral connection design.

Further, as shown in FIG. 14, the magnetic induction module 63 includes pins 635 connected to the circuit board 631, one end of each pin 635 is connected to the circuit board 631, and the other end of each pin 635 protrudes from the first side cap 6112 and is configured to be inserted into the external PCB, such as the motherboard of the gamepad, so as to realize the signal transmission between the magnetic induction module 63 and the motherboard. The second side cap 6113 may have a structure the same as or similar to that of the first side cap 6112, so as to realize assembly positioning of the magnetic induction module 63 in the second side cap 6113, which is not repeated herein.

Further, a receiving groove 61124 may be formed in the side of the bottom wall 61121 facing the rod seat 6111, and the magnetic induction member 633 is received in the receiving groove 61124, which provides an avoiding space for the magnetic induction member 633, avoids that the thickness of the magnetic induction member 633 and the thickness of the bottom wall 61121 are directly superposed to cause an excessively large size of the joystick structure 60, and improves the structural compactness of the joystick structure 60.

The embodiments above are only illustrative for the technical solutions of the present disclosure, rather than limiting the present disclosure. Although the present disclosure is described in detail with reference to the above embodiments, those of ordinary skill in the art should understand that they still can modify the technical solutions described in the foregoing various embodiments, or make equivalent substitutions on partial technical features; however, these modifications or substitutions do not make the nature of the corresponding technical solution depart from the spirit and scope of technical solutions of various embodiments of the present disclosure, and all should be included within the protection scope of the present disclosure.

1. A joystick structure, comprising:
a rod seat having a first sidewall;
a joystick movably arranged on the rod seat;
a linkage portion arranged on the rod seat;
a first rotating portion connected to the linkage portion and protruding from the first sidewall;
a magnet fixedly connected to the first rotating portion;
a first side cap fixedly connected to the first sidewall to receive the first rotating portion; and
a magnetic induction module integrally connected to the first side cap; the joystick being capable of driving the first rotating portion and the magnet to rotate relative to the first side cap and the magnetic induction module through the linkage portion.

2. The joystick structure according to claim 1, wherein the rod seat has a second sidewall connected to the first sidewall, the joystick structure comprises a second side cap fixedly connected to the second sidewall, another magnetic induction module integrally connected to the second side cap, a second rotating portion connected to the linkage portion, and another magnet fixedly connected to the second rotating portion, the second rotating portion protrudes from the second sidewall and is received in the second side cap, and the linkage portion is further capable of driving the second rotating portion and the other magnet to rotate relative to the second side cap and the other magnetic induction module.

3. The joystick structure according to claim 2, wherein the first rotating portion is provided with a sunken first placing groove, and the magnet is engaged in the first placing groove; the second rotating portion is provided with a sunken second placing groove, and the other magnet is engaged in the second placing groove.

4. The joystick structure according to claim 3, wherein a groove wall of the first placing groove is provided with at least two convex strips, and the convex strips abut against the magnet to engage the magnet in the first placing groove.

5. The joystick structure according to claim 3, wherein the linkage portion comprises a first linkage portion and a second linkage portion that are staggered on the rod seat, the first linkage portion is connected to the first rotating portion, the second linkage portion is connected to the second rotating portion, and the joystick passes through the first linkage portion and the second linkage portion and is configured to drive the first linkage portion and the second linkage portion to move respectively; the rod seat has a third sidewall connected to the first sidewall and the second sidewall, the first sidewall, the second sidewall and the third sidewall are pairwise perpendicular, the joystick extends out of the third sidewall, and openings of the first placing groove and the second placing groove face the third sidewall.

6. The joystick structure according to claim 5, wherein the first linkage portion is detachably connected to the first rotating portion, and the second linkage portion is detachably connected to the second rotating portion.

7. The joystick structure according to claim 5, wherein the first linkage portion and the first rotating portion are integrally formed, and the second linkage portion and the second rotating portion are integrally formed.

8. The joystick structure according to claim 5, wherein the joystick structure comprises an inner rod and a return spring, the joystick is provided with a through hole and a groove that are spaced apart, and the through hole extends from one end to the other opposite end of the joystick along an axial direction of the joystick; one end of the inner rod passes through the through hole, and the other end of the inner rod abuts against the rod seat; the return spring sleeves the inner rod, one end of the return spring is received in the groove and abuts against the joystick, and the other end of the return spring abuts against the inner rod.

9. The joystick structure according to claim 8, wherein the joystick comprises a limiting guide rail protruding from an inner wall of the through hole, an outer wall of the inner rod is provided with a guide groove matched with the limiting guide rail, and the limiting guide rail is matched and in sliding fit with the guide groove to limit relative rotation of the inner rod and the joystick.

10. The joystick structure according to claim 1, wherein the magnetic induction module comprises a circuit board and a magnetic induction member electrically connected to the circuit board, the magnetic induction member is arranged corresponding to the magnet, the circuit board is integrally connected to the first side cap, and the circuit board is configured to be electrically connected to an external motherboard.

11. The joystick structure according to claim 10, wherein the magnetic induction module comprises pins connected to the circuit board, and one end of each pin protrudes from the first side cap and is configured to be plugged into the external motherboard.

12. The joystick structure according to claim 10, wherein the first side cap comprises a bottom wall and a blocking wall that are integrally formed, the blocking wall extends along an edge of the bottom wall, and the bottom wall and the blocking wall together define a receiving cavity; at least three positioning posts arranged at intervals protrude from a side of the bottom wall facing the rod seat, the circuit board and the first rotating portion are received in the receiving cavity, at least three positioning holes in one-to-one correspondence to and in plugged fit with the positioning posts are formed in the circuit board, and the magnetic induction member is arranged on a side of the circuit board facing away from the rod seat.

13. The joystick structure according to claim 12, wherein a receiving groove is formed in the side of the bottom wall facing the rod seat, and the magnetic induction member is received in the receiving groove.
